(19) United States
(12) Patent Application Publication
(10) Pub. No.: US 2005/0276725 A1
(43) Pub. Date: Dec. 15, 2005

(54) Smart biochemical sample plate with an electronic memory device for high throughput sample analysis

(75) Inventor: Valdimir Mordekhay, Campbell, CA (US)

Correspondence Address: Vladimir Mordekhay;c/o V. Balter, 1045 Lassen Drive, Menlo Park, CA, 94025, US

(73) Assignee: Automated Biotechnology, Inc.

(21) Appl. No.: 11/166,025

(22) Filed: Jun. 27, 2005

Related U.S. Application Data
(62) Division of application No. 10/706,011, filed on Nov. 10, 2003, now abandoned.

(51) Int. Cl. B01L 3/00

(52) U.S. Cl. 422/68.1; 422/102

(57) ABSTRACT

A sample plate with built-in electronic memory for high throughput analysis of samples, e.g., for MALDI analysis, that contains a sample plate body with means that indirectly assists the analysis, such as nanonozzles that spray the sample from the sample plate to the analyzing equipment) or directly participate in the analysis, such as a layer of a substance that possesses physical or chemical affinity to the sample. The sample plate body or a body with a frame that supports the sample plate body incorporates an electronic memory device having data input and data output means for inputting and outputting information relating to sample analysis, samples, sample plates, analysis, etc. The sample plate is provided with a geometrical feature for unique orientation of the sample plate and/or electronic memory device relative to the analyzing equipment.

### CROSS-REFERENCE TO RELATED APPLICATIONS

The present patent application is a divisional of pending U.S. patent application Ser. No. 10/706,011 field on Nov. 10, 2003 by the same applicant.

### FIELD OF THE INVENTION

The present invention relates to the field of chemistry, analytical chemistry and biochemistry, and in particular to the devices for high throughput sample analysis.

### PRIOR ART AND DISADVANTAGE OF THE PRIOR ART

In a modern biochemical lab, in order to achieve higher throughput and productivity, it is common to process simultaneously a plurality of samples. In this case, multiple samples are commonly delivered to a substrate (called a sample plate or a sample analyzing chip) with single or multiple sample holding locations. For example, actual samples are often analyzed with a filtering step as a part of the analysis. This step is often performed in a parallel fashion using special multi sample filtering plates (see, e.g., sample filtering plates of 3M Inc, Minnesota, USA, model #6060, 96-well Empore Filter Plate). In such a plate, multiple samples are loaded into and removed from the same sample filtering plate. In this 96-sample filtering or sample cleaning plate, each channel is a through channel, which is filled with an absorbing material or cartridge. Commonly, the sample is loaded into this filtering sample plate to perform sample purification or separation. Depending on the sample and absorbent material natures, the sample can be retained on the absorbent material or can be eluted into another standard sample plate which is placed underneath the separation or filtering sample plate.

Another example of the prior-art device is a flat metal plate divided into individual regions (typically 96 or 384) used for a matrix assisted laser desorption ionization (MALDI) technique. A liquid sample is deposited on required places of the plate. After the sample dries, the plate is transferred to a mass spectrometer for composition analysis. This device is also available commercially, for example, from MassTech Inc, MD, USA.

Yet, another example of the device can be a glass plate that has a number of spots with selective reactivity to specific chemicals. This plate can be exposed to a solution that has to be analyzed. Depending on specific reactivity on each spot, specific chemicals of the analyzed solution will or will not react on different spots of the plate. Also, because of this reaction, each spot can change its optical properties (for example, it can lose or obtain a fluorescent chemical group from the die-labeled sample). For reading the information on the plate, it is placed into a fluorescent optical spectrometer that obtains information on each spot. For example, Agilent technologies, Inc, USA, manufactures a DNA micro array chip and the optical scanning device (DNA Microarray Scanner, Model G2565BA) to analyze DNA chips.

In all of the above cases, multiple-sample storage and processing devices can be called biochemical chips, and it is quite common to use attached (or engraved) bar code labels to track the individual devices and the associated data. A bar code method of tracking biochemical devices is limited to the amount of information that can be delivered by a bar code. Therefore, a different set of more complete records has to be carried by the samples and processes that are referenced by the bar code number. These records can be easily distributed between different computers, sample processing stations, and operators lab books making it difficult to ensure integrity and consistency of the records. It may be also difficult to generate error-free final reports while performing high throughput analysis.

It is also common that biochemical chips have to be transferred from one processing station to another (for example from a sample deposition station to an incubating or analyzing station). Normally, the sequence of these processes is performed by an operator and is subject to human errors, while documentation of the processes requires an extra effort from the operator. With bar code labels, it is also difficult to change or modify label information dynamically during chip processing.

Along with a bar code, a chemical biochip may also carry a magnetic tape storage device. However, this type of memory is quite delicate and somewhat unreliable, especially in the environment of chemical labs.

In order to eliminate the above disadvantages of the prior art, the applicant has developed a system of sample-plate carriers disclosed in pending U.S. patent application Ser. No. 10/624,399 filed on Jul. 21, 2003. According to the principle of the aforementioned invention, biochemical chips (hereinafter referred to as sample plates) with samples are inserted into sample plate carriers, which are used for handling the sample plates with mechanical grippers of the sample plate handling mechanism. Such a mechanism may comprise a mechanical arm of a separately installed industrial robot or a gripper of a carrier handling mechanism attached to a mass spectrometer. The use of sample plate carriers prevents direct contact of the grippers with sample plates and thus protects the samples and the sample plates from contamination or damage.

Sample plate carriers disclosed in aforementioned U.S. patent application Ser. No. 10/624,399 are provided with built-in memory elements for inputting/outputting information relating to the samples, sample plates, or sample carriers. Such information may comprise description of the samples, description of the test procedure, description of all other events occurred with a specific sample plate or sample plate carrier, etc.

The system of plates with carriers is convenient and advantageous for operations with a relatively limited number of samples and sample plates.

However, in those applications that involve creation of sample banks required for generation of large-volume data bases, the use of intermediate elements, such as sample plate carriers, may become inconvenient and economically unjustifiable. This is because the carriers dictate the use of large storage cassettes. Furthermore, since the information about specific sample plates is stored in the memory elements, which are physically separated from the sample plates and are located on specific sample plate carriers, these two items, i.e., the specific sample plate and the specific sample carrier, have preferably to be bound to each other. It is understood that when these two items are physically separated, the information about the samples and sample plates, e.g., process history, can be lost. If one needs to obtain the information about a specific sample on a specific sample plate, he/she needs to have an access to the aforementioned specific sample carrier, to be more precise, to the memory element of the sample plate carrier. This is not always convenient since the sample plates and carriers are physically separable and therefore an extra caution is needed for tracing the locations of both the carriers and the sample plates. Furthermore, the sample carriers themselves are relatively complicated devices that occupy an addition space and increase the cost of the operations and of a sample plate handling system as a whole.

### OBJECTS AND SUMMARY OF THE INVENTION

It is an object of the present invention to provide a sample plate with built-in electronic memory for high throughput sample processing. It is a further object to provide a sample plate, for use in conjunction with the automated or semi-automated sample analyzing stations and with a non-removable electronic memory device that insures data integrity. Another object is to provide aforementioned sample plate with a built-in memory device suitable for creating sample banks required for generation of large-volume data bases. It is another object to provide a sample plate of the aforementioned type, which is simple in construction, convenient in use, and is economically justifiable. A further object is to provide a sample plate having means for reliably storing data about the samples and their treatments along with the samples themselves in a single-unit device. A further object of the invention is to provide the aforementioned sample plate suitable for MALDI mass spectrometry, electrospray mass spectrometry, Raman spectrometry, and optical spectrometry, in particular for analysis of genes and proteins with accumulation of large-volume information in the data base of a system associated with a sample data bank. Still another object is to provide the aforementioned sample plate with a memory device in the form of a smart biochip device having an electronic non-volatile re-recordable memory device. Still another object is to provide the aforementioned sample plate with a memory device in the form of a memory stick. Still another object is to provide the aforementioned sample plate with a memory device equipped with electronic memory for recording information or for location of the information on external computers. It is another object of the invention to provide a security device attached to the sample plate that would prevent unauthorized usage of the sample plate on standard equipment.

A sample plate processing system suitable for treating sample plates of the invention in its simplest version consists of a sample deposition station with a data input/output unit and a sample processing station for processing and/or analyzing samples carried by the sample plates. The sample processing station is also equipped with data input/output units. Both data input/output units interacts with an electronic memory permanently built into each sample plate for loading information into any sample plate which is processed by the stations or for retrieving information from the aforementioned plate at any current moment of the process. The aforementioned information may contain records of the event history and the current status of the samples and the respective sample plates.

Sample plates of the present invention are provided with memory devices that may be permanently attached to respective plates and therefore cannot be accidentally separated from the plates during storage or processing. The memory device may incorporate a microprocessor and store information about the samples, processes, history of treatment, etc. Since the crucial information is stored directly on the sample plate and transferred to appropriate data storage and processing units concurrently with physical transfer of the sample plates, this information can be utilized for making decisions on current and subsequent processes. A dynamically modified program can be also recorded to the sample plate to alternate or enhance initial processing program prerecorded in the memory device. Different chemical sample treatment and analyzing processes can be implemented on the sample plate, depending on the final objective of the analysis. Such treatment and analysis can be represented, e.g., by the following processes: thin layer chromatographic separation, 2D gel electrophoresis, 1D gel electrophoresis, capillary electrophoresis, liquid chromatography, filtration, affinity sample trapping, multiple nozzle delivery systems, substrates for mass spectrometry, etc. The invention also relates to a method for using the aforementioned sample plates with built-in memory in various real-time high throughput analysis systems with dynamically modified programs. This method makes it possible to use the sample plates with memory in sample analysis and processing systems with interactive dialog between the memory unit of the sample plate and the memory units of the processing stations for dynamical change of the programs depending on the results of the current analysis.

### BRIEF DESCRIPTION OF THE DRAWINGS

FIG. 1A is a three-dimensional front-side view of the sample plate made in accordance with one embodiment of the present invention for MALDI analysis of a plurality of samples loaded onto individual spots.

FIG. 1B is a three-dimensional back-side view of the sample plate of FIG. 1A.

FIG. 2 shows a schematic structure of a system suitable for processing memory-containing sample plates of the invention.

FIG. 3A is a three-dimensional view of a sample plate of a second embodiment which is intended for filtration or chromatographic analysis of the samples.

FIG. 3B is a back view of the sample plate of FIG. 3A.

FIG. 4 shows a sample plate assembly of a third embodiment that consists of a frame and a sample plate body with channels and nozzles for spraying the samples, e.g., to a mass spectrometer.

FIG. 5 shows a transparent sample plate of a fourth embodiment of the present invention for fluorescent analysis.

FIG. 6 shows a sample plate of a fifth embodiment of the present invention for thin-layer chromatrography (TLC).

FIG. 7 shows another arrangement of a sample-plate processing system suitable for processing sample plates of the invention.

FIG. 8 shows a sample plate or slide of a sixth embodiment for electrophoretic analysis.

FIG. 9 shows an embodiment of a sample plate with a built-in memory device that has wireless input/output means.

### DETAILED DESCRIPTION OF THE INVENTION

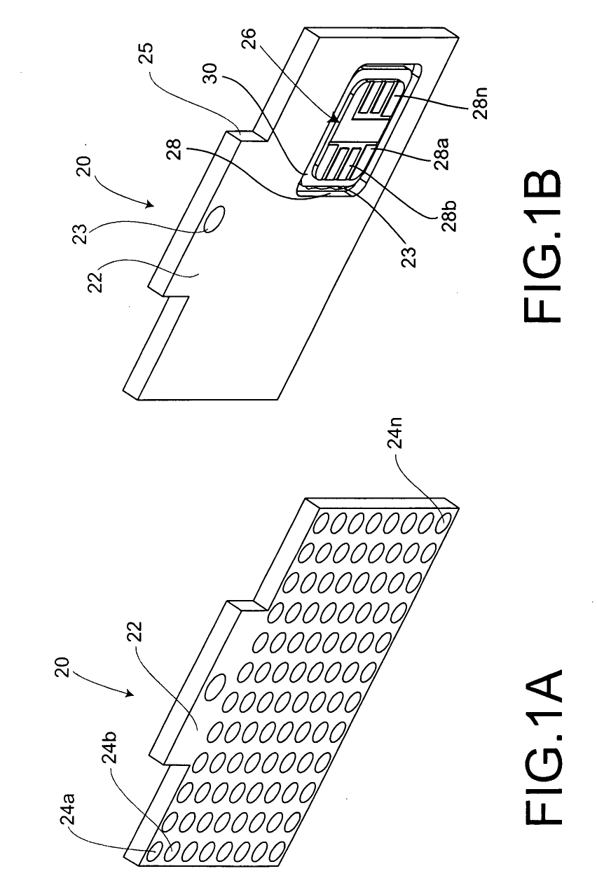

A sample plate made in accordance with one embodiment of the present invention and equipped with an electronic memory is shown in FIGS. 1A and 1B, where FIG. 1A is a three-dimensional front-side view of the sample plate made in accordance with one embodiment, and FIG. 1B is a three-dimensional back-side view of the sample plate.

As can be seen from the drawings, a sample plate 20 of the invention, e.g., for matrix assisted laser desorption ionization (MALDI) mass spectrometry consists of a solid body plate 22 divided into individual sample plate wells or spots formed, e.g., by engraving circular surface areas 24a, 24b, . . . 24n, and an electronic memory device 26 (hereinafter referred to as memory device) for storing information. As it is known in the art, circular areas 24a, 24b, . . . 24n may be made either from a special material or have special surface coatings or surface texture required for MALDI analysis. For example, the circular areas may be a polished gold or special stainless steel surface or a surface of special chemical affinity. Each specific surface may require different settings for the sample analysis, such as power of the irradiating laser in MALDI related to the surface of the sample plate. Therefore, in the context of the present invention we can consider the surface of the aforementioned plate as an analysis-participating means. Depending on the type of the analysis, the samples can be either destructed or non-destructed. If necessary, after analysis the samples can be removed, e.g., by washing out.

The memory device 26 may be a programmable electronic memory device or a permanent electronic memory device and may have a plurality of individual electrical contacts 28a, 28b, . . . 28n for powering the device and for interfacing the memory device with external data inputting/outputting devices. Although eight electrical contacts are shown in FIG. 1B, their number may be different. The memory device 26 can be a commercially available “smart chip” device that is commonly used in banking cards, telephone cards, and the like. Smart cards are secure, compact and intelligent data carriers. Though they lack screens and keyboards, smart cards should be regarded as specialized computers capable of processing, storing, and safeguarding thousands of bytes of data. Similar in size and shape to plastic credit cards, smart cards with electrical contacts have a thin metallic plate just above center line on one side of the card. Beneath this dime-sized plate is an integrated circuit (IC) chip containing a central processing unit (CPU), random access memory (RAM), and non-volatile data storage. Data stored in the smart card's microchip can be accessed only through the chip operating system (COS), providing a high level of data security. This security takes the form of passwords that allow a user to access parts of the IC chip's memory or encryption/decryption measures, which translate the bytes stored in memory into information.

According to the invention, security means comprise a security information inputted into the non-volatile data storage and consisting of at least one password. The security function can compare inputted passwords to see if they satisfy the function criteria.

The International Standards Organization (ISO) has developed a standard (ISO 7816) for integrated-circuit cards with electrical contacts. This standard defines physical dimensions of smart cards and their resistance to static electricity, electromagnetic radiation, and bending forces. It incorporates other ISO standards that establish the location, as options, of the card's magnetic stripe and embossed data. Most smart cards have eight electrical contacts (as shown in FIG. 1B), but only five have been defined by ISO 7816 and must be active.

A typical smart card contains a chip operating system (COS), file directory structure, and a “mask” of preprogrammed instructions. These vary from one manufacturer to another and, sometimes, from one card to another within the same vendor's line of products. There is no standard COS for smart cards and read/write devices. To assure an application that can operate with products of multiple vendors, a software program must translate application commands and functions into a language specific to each card and its COS. This program, which is logically positioned between the application and the COS, is called an application programming interface, or API.

Interoperability does not happen by accident with smart cards; it must be planned and programmed. Because an API can translate between smart cards and read/write devices from multiple vendors, an API is critical to the migration from paper-based methods to a system of interactive electronic documents based on smart cards. Smart cards are produced by various manufacturers, such as Atmel (California), Dallas Semiconductor (Texas), Hitachi Semiconductor (Japan), and many others.

The memory device 26 can be inserted into a recess 28 formed in the solid body of the plate 22 and can be fixed in the recess by an appropriate adhesive 23 or by other means. The solid body plate 22 may have a geometrical form and dimensions to be compatible with a specific analysis system or apparatus, e.g., with Mass Tech Inc. (MD, USA) atmospheric pressure laser assisted ionization apparatus. For example, the sample plate of the embodiment shown in FIG. 1B is provided with a non-symmetrical geometrical feature, such as a tab 25 or/and an opening 23 intended for unique orientation with the handling means of the analysis apparatus. In conventional sample plates such orientation features are normally used for orientation of the plate when it is inserted manually, e.g., into the handling means of the analyzing station. For the purposes of the invention, however, this feature is more important since the sample is designed for automatic or semi-automatic loading and determines position of the memory device relative to the memory reading unit of the analyzing apparatus.

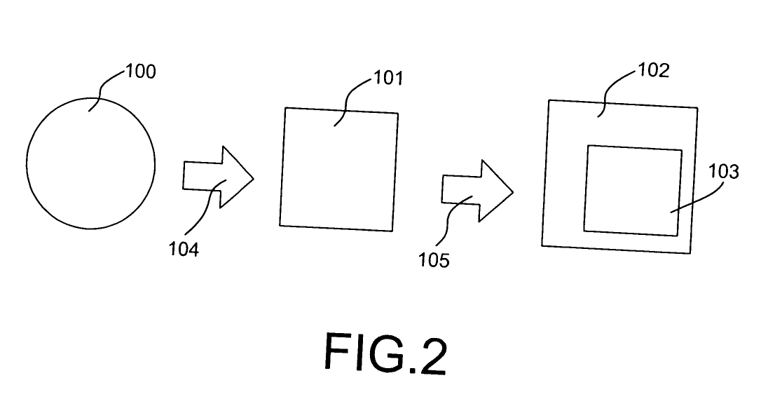

FIG. 2 shows an example of a system for sample plates of the invention described above. The system may have different arrangements, and the one shown in FIG. 2 consists of an input station 100 for loading information into sample plates, a sample plate loading station 101 for physically loading samples into sample plates in accordance with the aforementioned information inputted into the memory of plates, and a sample analyzer station 102 that contains an analyzing unit 103, e.g., a mass spectrometer. Loading of the liquid samples can be carried out, e.g., with the use of an automatic loading unit such as HTS PAL produced by CTC Analytics AG (Germany). This unit can be used for loading the sample plates with samples and sample processing chemicals, e.g., dilution solvent. The station can maintain the samples at a permanent temperature. At the station 102 the sample can be analyzed, e.g., by partially destructive sample analysis such as atmospheric pressure MALDI technique with a LCQ Deca XP Plus mass spectrometer operating with the use of the AP MALDI ion source (OPTON-30013) from Thermo Finnigan Co., Inc. The stations 100, 101, and 102 are equipped with standard data input/output units. In other cases, the sample may be analyzed by non-destructive methods such as Raman and infrared microspectroscopy, e.g., with the use the LabRam IR spectrometric system produced by Jobin Yvon Inc., New Jersey, USA. Another analyzing technique is laser-induced fluorescent spectroscopy of samples on the sample plates of the invention. This technical can be performed, e.g., by means of GeneChip Scanner 3000 produced by Affymetrix, Inc., CA, USA.

In the embodiment illustrated in FIG. 1B, the station 101 records into the memory device 26 (FIG. 1B) a primary information about the sample/samples as well as the date and time of the sample preparation. The station 102 records the information on time of the analysis. It can also record analysis information such as positive sample identifications, the name of the sample files or even crucial processing data for the samples. If necessary, the station 100 may be used for writing into the memory device 26 (FIG. 1B) of the sample plate 20 a specific information in advance for further use by the automated system 101 and by the process information for loading data into the sample analyzing system 102. In this case, the memory device 26 is first loaded at the programming station 100 with information on the tasks that have to be performed subsequently in time by sample preparation station 101 and by the analyzing station 102.

According to invention, the information flow which is illustrated by arrows 104 and 105, coincides with physical movements of the sample plate 20 from station to station, since the information is actually stored in the memory device 26 directly on the sample plate 20 (FIGS. 1A and 1B). In other words, the sample plate of the invention is suitable for use in sample analysis and processing systems with interactive dialog between the memory unit of the sample plate and the memory units of the processing stations for dynamical changes in the programs depending on the results of the current analysis.

It should be noted that according to the invention the memory device may be permanently attached to the sample plate 200 so that it cannot be accidentally disconnected from the plate. Here and hereinafter, the term “permanently attached” means that the memory device cannot be disconnected accidentally but can be disconnected and/or replaces when such disconnection or replacement has to be done intentionally, e.g., by an authorized person. For the purpose of confidentiality of the information stored in the memory device, the latter contains an identification code that is matched only to stations of the analysis system allowed for the use of a specific sample plate. If the sample plate is discarded, unauthorized persons will not be able to retrieve the information. This feature is especially important for person identification analysis of DNA samples stored in data banks.

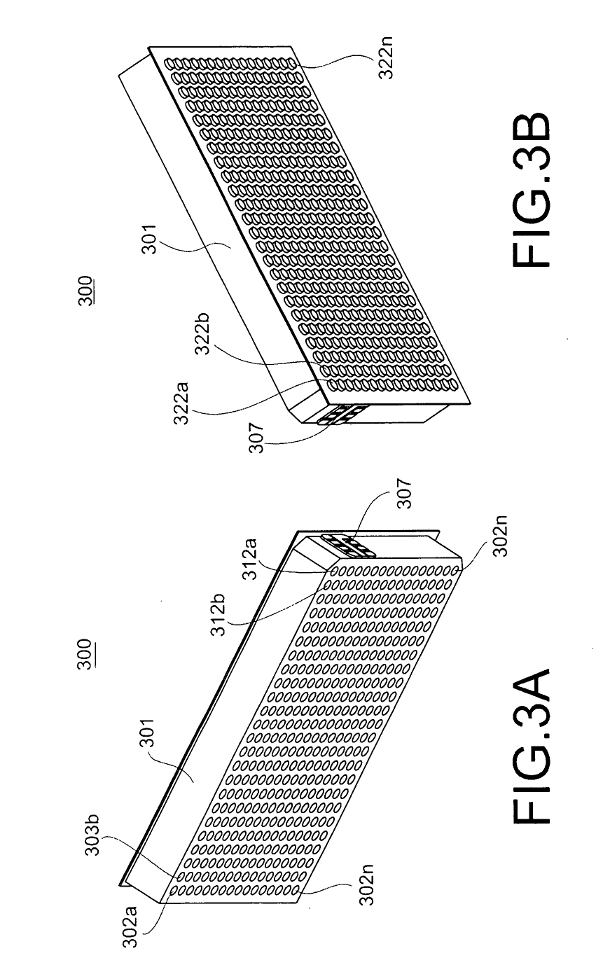

FIG. 3A and FIG. 3B are three-dimensional front-side and rear-side views, respectively, of a sample plate 300 according to a second embodiment of the invention. The sample plate 300 comprises a sample cleaning or purification device 301. The device 300 comprises a plate 301 made, e.g., of polypropylene, with a plurality of channels filled with chromatographic cartridges 302a, 303b . . . 302n., Each channel has an entrance opening, such as openings 312a, 312b, . . . 312n, for sample delivery and exit opening 32a, 322b, . . . 322n for the sample discharge. Similar to the previous embodiment, the sample cleaning device 300 incorporates a memory device 307. An example of a sample cleaning operation could be so-called solid-phase extraction (SPE) by 3M Company for cleaning samples with the Empore Extraction Disk Plates. The sample purification process consists of three steps: 1) loading the samples into the cells of the sample plate on the station 101 that may comprise, e.g., a liquid sample delivery unit; 2) washing the samples with the washing solution at the same unit 101; and 3) eluting the samples with an eluting solution, also at the station 101 (http://www.3m.com/empore/Library/Plates/Filter/instr3.htm).

The electronic memory device 307 can be preloaded with instructions on which sample and which solvents have to be applied to each or all of the chromatographic cartridges to provide desired sample treatment. Channels, such as channel 302a filled with chromatographic cartridges, is another example of sample analyze-participating means. Conditions for the sample analysis depend on dimensions of the channels and specificity of the chromatographic cartridge.

The eluted purified sample produced by passing samples through the device 300 (FIGS. 3A and 3B) of the second embodiment can be loaded, e.g., into the sample plate 20-of the first embodiment (FIGS. 1A and 1B). In this case, transfer of samples can be accompanied by transfer of the information stored in the memory device 307 (FIGS. 3A and 3B) to the memory device 26 of the sample plate 20.

The memory device 307 may be permanently attached to the sample plate 300, e.g., by adhesive (not shown), so that it cannot be disconnected from the plate. The memory device 307 stores the identification code that allows the use of the sample plate 300 only for authorized users, so that the sample plate 300 can be discarded without a risk of access to the information by unauthorized persons.

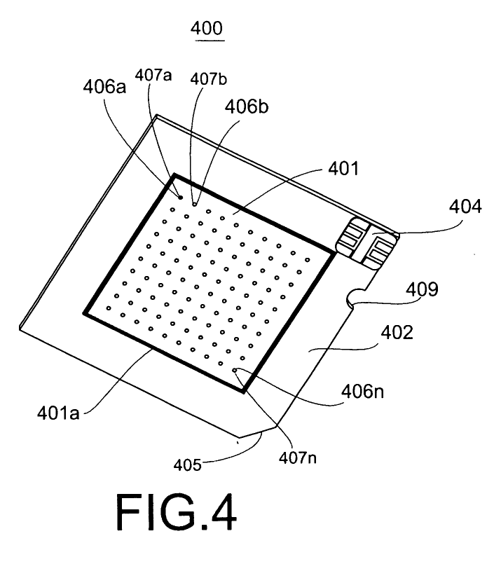

FIG. 4 shows a sample plate according to a third embodiment of the present invention. In the third embodiment, a sample plate 400 of the present invention can be a set of nanospray nozzles 406a, 406b, . . . 406n which are made as extensions of micro-machined channels 407a, 407b . . . 407n in the material of the silicon wafer 401. The wafer that in this specific embodiment comprises a sample plate is inserted into a frame or holding plate 402 and secured therein, e.g., by an adhesive 401a. A similar sample plate but without a memory device is commercially produced and is available from Advion BioSciences, Inc. and is marketed under the name Advion's “ESI chip”™ (www.advion.com), wherein the construction for the nozzles and channels are described, for example, in the U.S. Pat. No. 6,579,452. However, in contrast to the prior art, the sample plate 400 of the invention is equipped with an electronic memory device 404 mounted directly on the holding plate 402. The memory device 404 may store information, e.g., about the samples, treatment and analysis processes, etc. As in the previous embodiments, the memory device 404 may contain an identification code. Channels and nozzles, such as channel 400a and nozzle 407a, are others example of sample analyze-participating means. The conditions for sample analysis, such as analysis that involves spraying under effect of electrostatic field or sample flow may depend on the size of the channels and configuration of the nozzles.

The samples are preferably transferred to the spraying nozzles 406a, 406b, . . . 406n (FIG. 4) from the device 200 (FIGS. 3A to 3B) by a robotic loading station, such as the one produced by Advion Inc, NY, USA, model Nanomate 100. Non-symmetrical orientation features such as a chamfered corner 405 or semicircular recess 409 formed on the peripheries of the frame 402 provide a unique orientation of the sample plate of the present invention within an analyzing robotic station. Such a robotic station may be incorporated into the aforementioned analyzing station 102 (FIG. 2) with a mass spectrometer such as the one produced by the LCQ Deca XP Plus from Thermo Finnigan Co., Inc.

In this case, according to the invention the results of the analysis can also be recorded in the memory device 202 of the sample plate 200 which also can be used for sample storage within the Nanomate 100 sample loading station. This information can be used to decide on future sample processing including but not limiting to sample archiving or additional sample treatment or analysis.

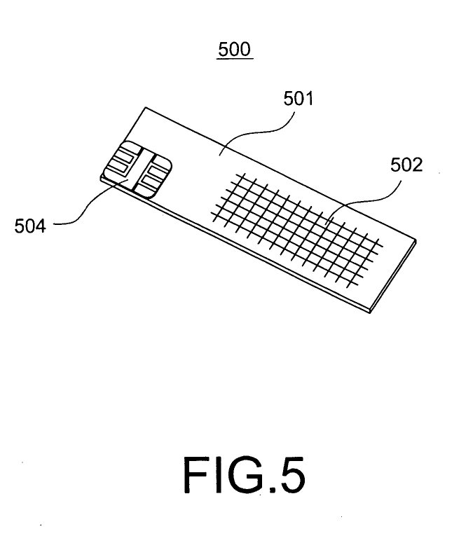

FIG. 5 shows a sample plate according to a fourth embodiment of the present invention. In the fourth embodiment, a sample plate 500 may comprise a light-transparent material such glass or quartz slide 501 with a predeposited array of active spots 502 that possess chemical affinity to specific samples. An active spots 502 that possess chemical affinity to specific samples of the predeposited array of chemical substances is another example of sample analyze-participating means of the present invention. The sample plate or the smart chemical biochip 500 is also provided with a memory device 504 of the same type as in the first embodiment (FIGS. 1A, 1B), which is permanently attached to the glass slide 501. The memory device 504 can be loaded with crucial information on the sample, deposited spots, results of the analysis, e.g., obtained by fluorescent spectroscopy technique by a scanning device (such as model—DNA Microarray Scanner, Model G2565BA, Agilent Technologies, CA, USA), or the like. Such an optical microarray reader may represent the aforementioned data analysis unit 103 incorporated into the sample analyzing station 102.

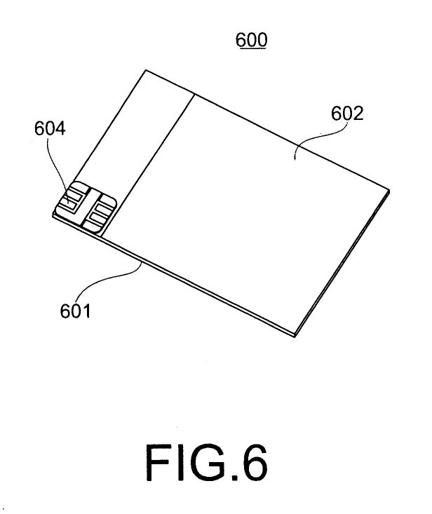

FIG. 6 shows a sample plate of the fifth embodiment of the present invention. In the fifth embodiment a sample plate 600 may comprise a thin-layer chromatography slide 601 equipped with a memory device 604 of the same type as in the first embodiment (FIGS. 1A and 1B). Samples are loaded on an active chromatography layer 602, as is well known in the art. An active chromatography layer 602 is yet another example of sample analyze-participating means of the present invention.

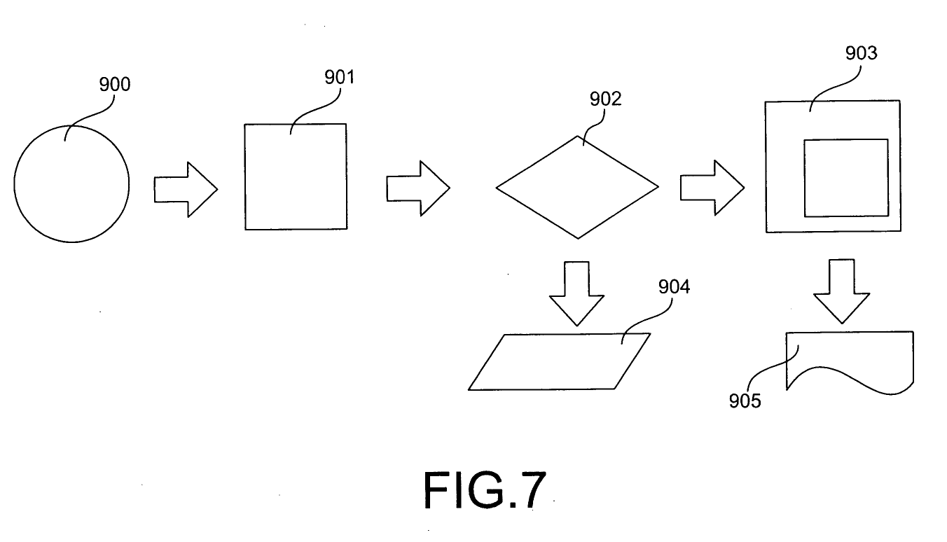

FIG. 7 illustrates another arrangement of the sample plate processing system, -which is suitable for analysis, e.g., of the sample plate 600 of FIG. 6. The system consists of a computer-controlled information input/output data station 900, a sample loading station 901, a sample-plate screening and distribution station 902, and an analytical station 903, e.g., a mass spectrometer. Reference numeral 904 designates a sample plate recycling container, and 905 designates a sample plate storage. The arrows in FIG. 7 show the path of the sample plates through the system.

At station 900, the memory device 604 of the sample plate 600 (FIG. 6) can be loaded with detailed information on the type of the analysis to perform on subsequent stations (FIG. 7). Then sample plates are transferred to the next station either by the robotic device or by a human operator. When the plate 600 arrives at the combined optical reader/sample screening device and the sample deposition station 901, this information is inputted to the station 901 from the memory device 604 of the sample plate 600. For example, for analysis of a specific drug, station 901 may have information that a positive sample identification will correspond to darker regions on a separating layer that is located at a specified distance from the original sample deposition spot.

For all positive samples, this information can be sent from the optical reader 901 back to the memory device 604 of the sample plate 600. At a station 902, this information can be obtained from memory device 604 of the sample plate 600, and a decision can be made at the station 902 either to dispose the sample plate 600 to a recycle container 904 or to send it for conformation analysis to a mass spectrometer station 903. After completing the conformation analysis by station 903, the sample plate 600 can be transferred to an archive 905.

The arrows in FIG. 7 illustrate both the information flow and physical movements of the sample plate between the processing stations. It is recognized, that the decision-making station 902 can be either a part of other sample processing stations that suggests the operator the subsequent desirable processing steps for the sample plate 600 or it can be a fully automated stand-along robotic device. It is recognized that according to the invention the decision on the next process for the sample plate 600 can be actually generated within the memory device of the sample plate by providing the memory device 604 with a microprocessor unit.

Thus, it has been shown that the invention provides a sample plate that makes the sample plate suitable for use in sample analysis and processing systems with interactive dialog between the memory unit of the sample plate and the memory units of the processing stations for dynamical change of the programs depending on the results of the current analysis.

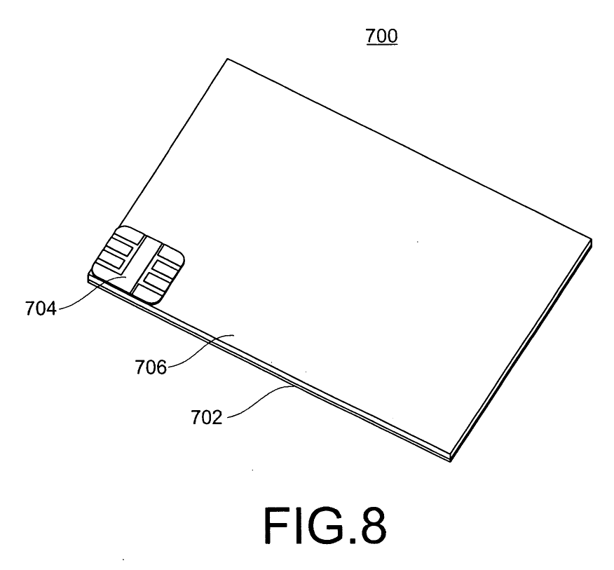

FIG. 8 shows a sample plate of the sixth embodiment of the present invention. In the sixth embodiment, a sample plate 700 may comprise a gel electrophoresis slide 701 for electrophoretic separation equipped with a memory device 704 of the type described with reference to the first embodiment of the invention (FIGS. 1A and 1B). Samples are loaded into a gel layer 702 in a manner known in the art, and the memory device 704 is loaded with information for transfer to an optical reader device that is similar to device 901 of FIG. 7. To achieve the electrophoretic migration of the samples, an electric field is applied to the gel layer 702. In this embodiment, gel layer 702 is defined as sample analyze-participating means of the present invention. Under the effect of the field, the samples migrate. As different samples migrate differently, it is possible to identify the samples by their position on the plate. For example, for analysis of a specific protein sample, the information may relate to a positive sample identification, i.e., to black regions on the separating layer that is located at a certain distance from the original sample deposition spot. For all samples identified positive, the information can be sent from the optical reader 901 (FIG. 7) back to the memory device 704. Later this information can be used to remove samples from the identified spots and to transfer them for further analysis, for example by the mass spectrometric techniques.

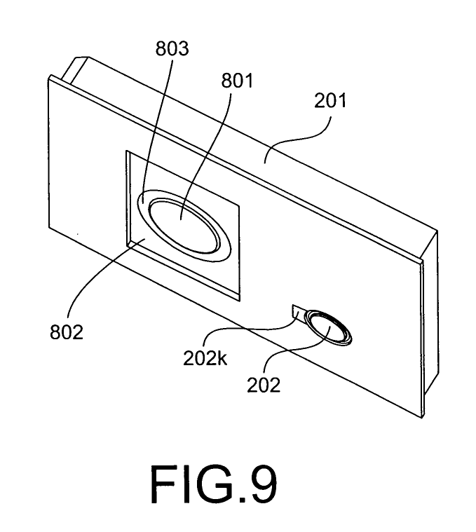

FIG. 9 shows an embodiment of a sample plate that in addition to the memory unit 202 with electrical contacts 202a and 202k has a built-in electronic memory 801 having wireless connection to input/output stations such as the stations 900, 901, etc., shown in FIG. 7. The analysis participating means are not shown on FIG. 9, but may be identical to any analysis participating means described above, for example, to the analysis participating means described in the first embodiment for MALDI mass spectrometry. Reference number 802 designates a recess for the location of the memory unit 801 in the sample plate body 201. The memory unit is sealed with a protective film 803 that also serves as means for securing the memory unit in place. The wireless connection of the memory unit with the stations allows one to access information without physical contact with the sample plate. As the existing wireless memory units have capacity inferior to those with the physical contact, it may be advantageous to provide the sample plate with both contact and contactless memory devices. An example of a wireless memory unit may be a device produced by HID Corporation, Irvine, Calif., USA (for example models: MicroProx Tag or ProxCard II) with wireless interface built into proximity tags.

Thus, it has been shown that all embodiments of the sample plates of the present invention differ from the known sample plates in that they do not simply passively hold the samples for analysis but are provided with means that directly or indirectly participate in the analysis of the samples. Examples of such means that directly participate in the analysis are an active layers deposited on a flat surfaces of the sample plates, a pre-deposited array of active spots 502 on the sample plate of FIG. 6 with sample separation chromatographic activity, a pre-deposited gel material for electro-osmotic separation, e.g., in a sample plate 700 shown in FIG. 9, etc.

It is also interesting to note, that complexity of the information may greatly increase if one sample plate contains analysis participating means of different types, e.g., nozzles and channels, or nozzles, channels, and chromatographic cartridges, etc. The complexity of information may also increase with an increase in the number of samples. In both cases the advantages of streamlining of the information workflow in the analyzing lab are matters of greater importance for the sample plates of the invention than to the sample plates of the prior art. This is because the entire or a part of the information on samples, on sample analysis, and on the results of the analysis can be stored and transferred along with the memory devices that are built into the sample plates or their holders. If the analyzing stations are automated with an automatic or semi-automatic sample plate loading device, it is increasingly important that sample plates would have a mechanical orientation feature for loading sample plates in a unique predefined position, thus providing flexible flow-less high throughput workflow in the sample analyzing lab.

While the invention has been described with reference to specific embodiments, the description is illustrative of the invention and is not to be considered as limiting the invention. Various modifications and applications may occur to those skilled in the art without departing from the true spirit and scope of the invention. For example, it is recognized that various electronic memory devices may be used and they may have different read/write interfaces including but not limiting to USB port interfaces (such as an USB memory stick device), flash memory cards (such as flash cards used in the commercial electronic cameras), etc. It is recognized that non-volatile electronic memory used in the present invention may have a final life span (it has to be long enough to provide sufficient time from the beginning to the end of the chip processing and possibly archiving). Also, it is recognized that fully encapsulated electronic memory devices can have certain advantages for the specific applications where aggressive chemicals are present. It is recognized, that different shapes and geometries can be used for the sample plates of the present invention. It is also recognized that sample plates of the invention with built-in memory may be disposable devices. It is recognized that information can be also encoded or encrypted into the electronic memory for the data confidentiality. It is recognized that devices of the present invention can be used along with existing technology such as bar code labels as well as information storage on computer files separately from the sample plates of the present invention. The sample plates of the invention may be used in conjunction with stations other than those described in the specification and their memory chips may store data and commands different from those described above. The system is also applicable for targeted specific chemical or physical chemical modification of samples, e.g., for modifying genes in DNA samples.

1. A sample plate with built-in electronic memory for analyzing at least one sample comprising:
a sample plate body;
analysis-participating means that are supported by said sample plate body;
an electronic memory device that is incorporated into said sample plate, said electronic memory device having data input and data output means for inputting and outputting information relating to said high throughput analysis;
means for attaching said electronic memory device to said sample plate, said electronic memory device being selected from a programmable electronic memory device and a permanent electronic memory device;
said data input and data output means for inputting and outputting information being selected from wireless data input and data output means and electrical contacts.

2. The sample plate of claim 1, wherein said sample plate further comprises a frame for holding said sample plate body, said means for attaching said electronic memory device to said sample plate being selected from means for attaching said electronic memory device to said sample plate body and means for attaching said electronic memory device to said frame.

3. The sample plate of claim 1, wherein said analysis-participating means is selected from the group consisting of at least one through channel that passes through said sample plate body and is intended for passing said at least one sample, at least one nozzle intended for spraying said at least one sample, at least one chromatographic medium, at least one filtration medium, at least one chromatographic cartridge, at least one chromatographic layer, at least one gel substance for electro-osmotic separation, and at least one special surface for matrix assisted laser desorption ionization mass spectrometry.

4. The sample plate of claim 2, wherein said analysis-participating means is selected from the group consisting of at least one through channel that passes through said sample plate body and is intended for passing said at least one sample, at least one nozzle intended for spraying said at least one sample, at least one chromatographic medium, at least one filtration medium, at least one chromatographic cartridge, at least one chromatographic layer, at least one gel substance for electro-osmotic separation, and at least one special surface for matrix assisted laser desorption ionization mass spectrometry.

5. The sample plate of claim 1, wherein said analysis-participating means is a plurality of combined different analysis-participating means selected from the group consisting of at least one through channel that passes through said sample plate body and is intended for passing said at least one sample, at least one nozzle intended for spraying said at least one sample, at least one chromatographic medium, at least one filtration medium, at least one chromatographic cartridge, at least one chromatographic layer, at least one gel substance for electro-osmotic separation, and at least one special surface for matrix assisted laser desorption ionization mass spectrometry.

6. The sample plate of claim 2, wherein said analysis-participating means is a plurality of combined different analysis-participating means selected from the group consisting of at least one through channel that passes through said sample plate body and is intended for passing said at least one sample, at least one nozzle intended for spraying said at least one sample, at least one chromatographic medium, at least one filtration medium, at least one chromatographic cartridge, at least one chromatographic layer, at least one gel substance for electro-osmotic separation, and at least one special surface for matrix assisted laser desorption ionization mass spectrometry.

7. The sample plate of claim 1, wherein said sample plate body is made of a material transparent to light for optical analysis of said at least one sample.

8. The sample plate of claim 2, wherein said sample plate body is made of a material transparent to light for optical analysis of said at least one sample.

9. The sample plate of claim 1, wherein said sample plate further comprises an orientation feature for loading and unloading said sample plate and said electronic memory device with the unique orientation during said analysis.

10. The sample plate of claim 2, wherein said frame further comprises an orientation feature for loading and unloading said sample plate and said electronic memory device with the unique orientation during said analysis.

11. The sample plate of claim 10, wherein said analysis participating means comprise at least one nozzle for spraying said at least one sample through said at least one nozzle.

12. The sample plate of claim 9, wherein said analysis participating means comprise at least one spot of a substance reactive to at least one sample.

13. The sample plate of claim 10, wherein said analysis participating means comprise at least one fluorescent analysis assisting substance applied onto said sample plate.

14. The sample plate of claim 9, wherein said analysis participating means comprise at least one layer of an electrophoretic gel applied onto said sample plate.

15. The sample plate of claim 10, wherein said analysis participating means comprise at least one spot for matrix assisted laser desorption ionization mass spectrometry of said at least one sample.

16. The sample plate of claim 9, wherein said analysis participating means comprise at least one layer of a chromatographic medium applied onto said sample plate.

17. The sample plate of claim 10, wherein said analysis participating means comprise a chromatographic cartridge embedded into said sample plate.

18. The sample plate of claim 1, wherein said means for attaching said electronic memory device are permanent attaching means that prevent accidental disconnection of said electronic memory device from said sample plate.

19. The sample plate of claim 2, wherein said means for attaching said electronic memory device are permanent attaching means that prevent accidental disconnection of said electronic memory device from said frame.
